(19) United States
(12) Patent Application Publication
(10) Pub. No.: US 2003/0168050 A1
(43) Pub. Date: Sep. 11, 2003

(54) Inductive ignition device comprising a device for measuring an ionic current

(76) Inventors: Markus Ketterer, Stuttgart (DE); Achim Guenther, Sindelfingen (DE); Juergen Foerster, Ingersheim (DE)

Correspondence Address: Striker Striker & Stenby, 103 East Neck Road, Huntington, NY, 11743, US

(21) Appl. No.: 10/311,721

(22) PCT Filed: Apr. 6, 2001
(86) PCT No.: PCT/DE01/01343

(30) Foreign Application Priority Data
Jun. 28, 2000 (DE) 100 31 553.4

(51) Int. Cl. F02P 1/00

(52) U.S. Cl. 123/655; 123/656

(57) ABSTRACT

The invention relates to an inductive ignition device for an internal combustion engine, having an ignition coil (ZS) with a primary coil (L₁) and a secondary coil (L₂), wherein a diode (D) is provided on the side of the secondary coil (L₂), having a spark plug (ZK) with at least one electrode, and having a measuring device for detecting an ionic current (14). A shunt device (16) is provided in order to decrease a residual charge that is present between the diode (D) and an electrode of the spark plug (ZK). The shunt device (16) preferably contains a high-impedance resistance (R) connected in parallel with the diode (D). This permits a reliable detection of combustion misses in the ionic current signal.

### PRIOR ART

The invention relates to an inductive ignition device for an internal combustion engine, having an ignition coil with a primary coil and a secondary coil, in which a diode is provided on the side of the secondary coil, having a spark plug that has at least one electrode, and having a measuring device for detecting an ionic current.

In inductive ignition systems of motor vehicles with internal combustion engines, the circuit of the secondary coil, which supplies the ignition spark, is often equipped with a so-called initial spark suppression diode, which suppresses current possibly produced in the secondary coil circuit by the charging current of the primary coil.

In ignition systems, the measurement of the ionic current flowing through the spark plug during the combustion process offers a possibility of monitoring the combustion process, for example in order to detect combustion misses, knock detection, or for regulating the ignition time. One possible type of measuring the ionic current takes place by means of a measuring device, which is connected into the circuit of the secondary winding and measures the current flowing via the electrodes of the spark plug, primarily during the period of time following the end of the ignition spark. Based on the characteristics of the measured curve, conclusions can be drawn regarding the values mentioned above.

If there is now a residual charge remaining between the spark plug and the initial spark suppression diode, which occurs in an intensified fashion due to combustion misses, then this distorts the measurement.

The object of the invention, therefore, is to modify an ignition device of the type mentioned at the beginning to the extent that the ionic current measurement is protected from being distorted by residual charges.

### ADVANTAGES OF THE INVENTION

The ignition device with the characteristics of claim 1 has the advantage that a residual charge still present after the end of the ignition spark is discharged in a simple fashion so that the subsequently executed ionic current measurement is not distorted.

Preferably, the shunt device contains a high-impedance resistance connected in parallel with the diode. It has turned out that bridging over the initial spark suppression diode with a high-impedance resistance does not impair the function of the initial spark suppression diode and the ignition device, while residual charges can be discharged in the available period of time.

In a simple and space-saving shunt device according to the invention, the resistance is constituted by an electrically conductive, but high-impedance layer applied to the diode.

Another advantageous variant provides that the high-impedance resistance (R) is constituted by a doping on a component, which also contains the diode (D).

The diode with the parallel-connected resistance can, for example, be disposed in the ignition coil, in a plug connector of the spark plug, or in one of the high-voltage lines in the secondary coil circuit, which minimizes the number of required components.

Depending on the demands on the ignition device, the diode and the parallel connected resistance can be disposed on the high-voltage side or on the low-voltage side of the secondary winding.

Other advantageous features of the invention are disclosed in the dependent claims.

### DRAWINGS

The invention will be described below in conjunction with preferred embodiments depicted in the accompanying drawings.

FIG. 1a shows a section of the wiring diagram of an ignition device according to the invention, according to a first embodiment;

FIG. 1b shows a section of the wiring diagram of an ignition device according to the invention, according to a second embodiment;

FIG. 2 shows a wiring diagram of an ignition device from the prior art;

FIG. 3 shows a diagram of a measurement of the secondary voltage without a parallel resistance to the diode; and

FIG. 4 shows a diagram of a measurement of the secondary voltage with a parallel resistance to the diode.

### DESCRIPTION OF THE EXEMPLARY EMBODIMENTS

FIG. 2 shows a known inductive ignition device 10. The ignition device has an ignition coil ZS, which includes a primary coil L₁ and a secondary coil L₂ inductively coupled to this primary coil. The primary coil L₁ is connected to a battery with a battery voltage U_{ZS} and is triggered by a motor control unit 12 by means of a transistor T. The circuit containing the primary coil L₁ is referred to below as the primary coil circuit.

The ignition device 10 also includes a spark plug ZK, whose one electrode is connected by means of an initial spark suppression diode D to the end of the secondary coil L₂ that is on the high-voltage side during ignition operation. The second electrode of the spark plug ZK is connected to ground M. The diode D is connected so that it permits the flow of current from the coil L₂ to the spark plug ZK. The other end of the secondary coil L₂ that is on the low-voltage side during ignition operation is connected to an ionic current measuring device 14, which is in turn connected to ground M, for example, and supplies the ionic current Si as a measurement value. The circuit containing the secondary coil L₂ is referred to below as the secondary coil circuit.

As a rule, there is a stray capacitance C_{S} between the diode D and the middle electrode of the spark plug ZK. This stray capacitance C_{S} is based on the properties of the ignition coil, the high-voltage cable, and the spark plug and can be electrically modeled by the capacitance depicted in the drawing.

The ignition process occurs as follows: first, the motor control unit 12 switches the transistor T into a conductive state so that a current flow can occur in the primary coil L₁. At the selected ignition time, the motor control unit 12 switches the transistor T into a high-impedance state, thus interrupting the current flow in the primary coil circuit. By means of the inductive coupling, the magnetic field of the primary coil generates an induction current in the secondary coil L₂. The numbers of windings in the coils are matched to each other so that the coil L₂ generates a high-voltage pulse. The current direction here is selected so that a positive voltage is produced on the high-voltage side of the ignition coil L₂.

If the ignition voltage is achieved, an ignition spark jumps between the electrodes of the spark plug ZK and the spark plug becomes conductive. The spark current flows from the coil L₂, through the diode D and the spark plug, to ground and from there, via the ionic current measuring device 14, back to the coil L₂. This ignition spark normally ignites the air/fuel mixture in the cylinder and initiates the combustion process.

If the gas discharge is interrupted because the current falls below a value required to maintain the gas discharge in the spark plug ZK, the spark gap between the electrodes becomes abruptly high-impedance and the stray capacitance Cₛ is charged with the residual charge remaining in the ignition coil L₂. However, this charge can no longer be discharged so that a relatively high voltage remains in the stray capacitance C_{S}.

If a combustion occurs, then a residual charge thus produced can be discharged as soon as the combustion process initiated by the ignition spark begins since the ions generated by this produce a conductive connection between the electrodes of the spark plug ZK.

In this combustion phase, an ionic current measurement is executed, which records the current flow occurring during the combustion. To this end, the ionic current measurement device itself generates a voltage in the secondary coil circuit in order to move the ions to the electrodes of the spark plug. This ionic current is measured by the ionic current measuring device.

If a combustion miss occurs, then this means no combustion of the air/fuel mixture in the cylinder occurs, no ions are generated, and the ionic current measured is equal to zero. This permits combustion misses to be detected by means of the ionic current measurement.

In the event of a combustion miss, however, the residual charge remains after the end of the ignition spark, i.e. during the measurement period of the ionic current measurement, since it can neither overcome the presently high-impedance span between the electrodes of the spark plug nor be discharged via the oppositely polarized diode D that is polarized in the opposite direction. Since the downward motion of the piston causes the gas pressure in the cylinder to decrease and because of this, according to Paschen's law, the voltage required to ignite a gas discharge decreases, spontaneous, uncontrolled gas discharges occur as soon as the voltage generated by the residual charge is sufficient for an ignition, and as a result, a current flow through the ionic current measuring device 14 occurs.

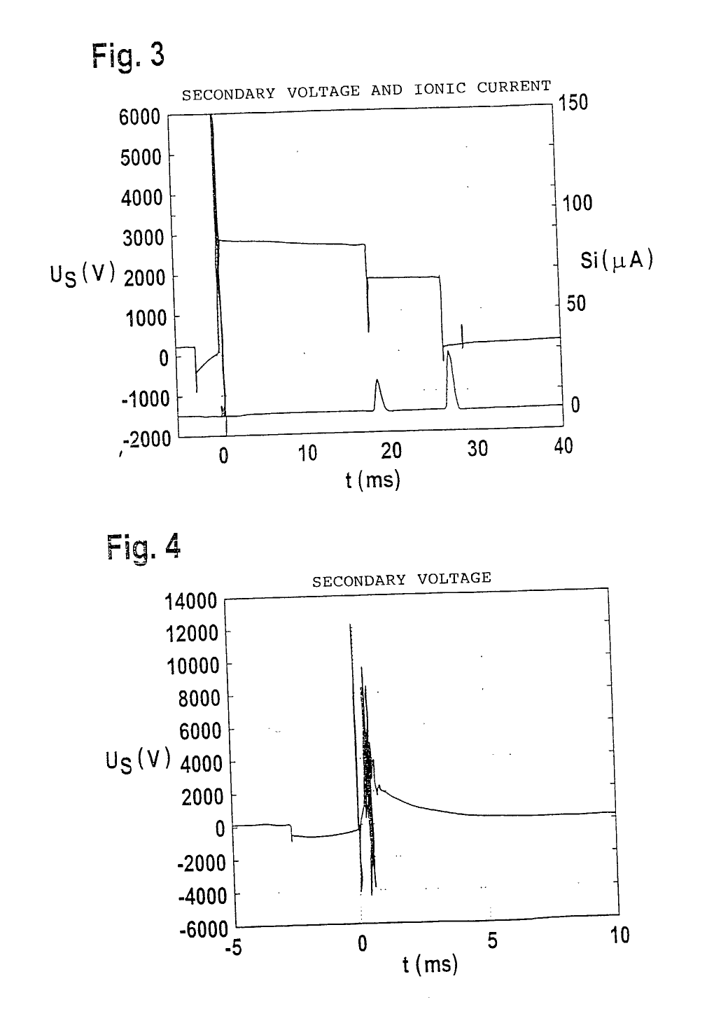

An example of this is shown in FIG. 3. The upper curve depicts the progression of the secondary voltage Uₛ measured between the diode D and the spark plug ZK. It is clear that after the end of the ignition spark, a residual charge of approx. 3000 V remains, which decreases afterward in two spontaneous gas discharges. The lower curve depicts the corresponding ionic current signal in which the current flow that can be attributed to gas discharges appears as respective peaks. Such interference signals distort the measurement and make it more difficult to evaluate the data, primarily for the detection of combustion misses in which the ionic current to be expected is in fact zero.

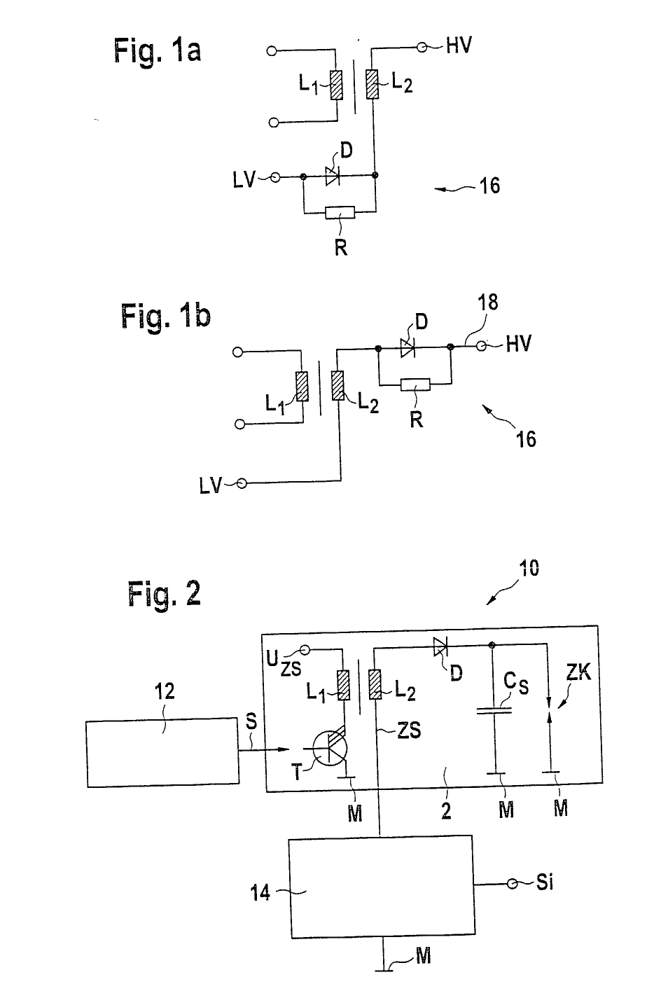

The ignition device according to the invention also has the components shown in FIG. 1, which will not be described again below. FIGS. 1a and 1b, therefore, only show the differences of the ignition device according to the invention from the one shown in FIG. 1.

In the secondary coil circuit, a shunt device 16 is provided, via which a possibly existing residual charge can be discharged to ground M. In the instance depicted, the shunt device is comprised of the assembly containing the diode D and a resistance R connected in parallel with it. The resistance R is selected so that on the whole, it does not impair the function of the diode D and the ignition device. A resistance on the order of magnitude of 10MΩ has turned out to be a suitable value.

The diode D and the resistance R connected in parallel with it can be disposed either on the low-voltage side LV of the coil L₂, as shown in FIG. 1a, or on the high-voltage side HV of the coil L₂, as shown in FIG. 1b.

The ignition device according to the invention functions as described above. However, the bridging-over of the diode D by the resistance R results in the fact that included charge carriers can be discharged to ground M via the resistance R so that a residual charge cannot build up between the diode D and the electrode of the spark plug ZK.

FIG. 4 shows the secondary voltage signal U_{S} for an ignition spark with a subsequent combustion miss, analogous to the situation shown in FIG. 3, in an ignition device according to the invention. It is clear that the residual charge is already almost completely reduced shortly after the end of the ignition spark. As a result, spontaneous gas discharges cannot occur during the subsequent pressure drop, so that no residual charge-induced interference in the ionic current signal Si can occur and combustion misses can be reliably detected by means of the ionic current signal.

In addition to being embodied as a conventional component, the resistance R can also be constituted, for example, by a conductive coating or a conductive sheathing of the diode D. It is also conceivable for the resistance to be constituted by doping on the same semiconductor element as the diode.

The combination of the diode D with the parallel-connected resistance R can be integrated in a space-saving manner, e.g. into the ignition coil, the spark plug cap, or one of the high-voltage lines 18 in the secondary coil circuit.

1. An inductive ignition device for an internal combustion engine, having an ignition coil (ZS) with a primary coil (L₁) and a secondary coil (L₂), wherein a diode (D) is provided on the side of the secondary coil (L₂), having a spark plug (ZK) with at least one electrode, and having a measuring device for detecting an ionic current (14), characterized in that a shunt device (16) is provided for discharging a residual charge present between the diode (D) and an electrode of the spark plug (ZK).

2. The ignition device according to claim 1, characterized in that the shunt device (16) contains a high-impedance resistance (R) connected in parallel with the diode (D).

3. The ignition device according to claim 2, characterized in that the high-impedance resistance (R) is constituted by a conductive layer applied to the diode (D).

4. The ignition device according to claim 2, characterized in that the high-impedance resistance (R) is constituted by a doping applied to a component that also contains the diode (D).

5. The ignition device according to one of claims 2 to 4, characterized in that the diode (D) and the resistance (R) are disposed in the ignition coil (ZS).

6. The ignition device according to one of claims 2 to 4, characterized in that the diode (D) and the resistance (R) are disposed in a plug connector of the spark plug (ZK).

7. The ignition device according to one of claims 2 to 4, characterized in that the diode (D) and the resistance (R) are disposed in a high-voltage line (18).

8. The ignition device according to one of claims 2 to 7, characterized in that the diode (D) and the resistance (R) are disposed on the high-voltage side of the secondary coil (L₂).

9. The ignition device according to one of claims 2 to 7, characterized in that the diode (D) and the resistance (R) are disposed on the low-voltage side of the secondary coil (L₂).
